(19) United States
(12) Patent Application Publication
(10) Pub. No.: US 2011/0256038 A1
(43) Pub. Date: Oct. 20, 2011

(54) Durham Tube Assembly

(76) Inventors: Quophyyarn Tinner, Crowley, TX (US); Bethany Morgan, Grand Prairie, TX (US); Nikki Goines, Arlington, TX (US)

(21) Appl. No.: 12/763,987

(22) Filed: Apr. 20, 2010

(51) Int. Cl. B01L 3/00

(52) U.S. Cl. 422/550

(57) ABSTRACT

The invention is a combination of a Durham tube and traditional chemistry test tube, with the Durham tube affixed upside down in the interior of a test tube. The Durham tube is secured so it does not move around, by constructing the test tube and Durham tube in one piece, or using a clip to keep it from moving.

### B. CROSS-REFERENCE TO RELATED APPLICATIONS

None

### C. STATEMENT REGARDING FEDERALLY SPONSORED RESEARCH OR DEVELOPMENT

Not Applicable

### D. THE NAMES OF THE PARTIES TO A JOINT RESEARCH AGREEMENT

Not Applicable

### E. REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC.

Not Applicable

### F. BACKGROUND OF THE INVENTION

(1) Field of the Invention

The present invention pertains to test tubes used in chemical analysis.

(2) Description of the Related Art Including Information Disclosed Under 37 Cfr 1.97 and 1.98.

Durham tubes are known to those with ordinary skill in microbiology, who use them to detect production of gas by microorganisms. They are simply smaller test tubes inserted upside down in another test tube. This small tube is initially filled with the solution in which the microorganism is to be grown. If gas is produced after inoculation and incubation, a visible gas bubble will be trapped inside the small tube. The initial air gap produced when the tube is inserted upside down is lost during sterilization, usually performed at 121° C. for 15 or so minutes.

Durham tubes often bounce around during chemical processes. The tubes can break or chip during the process, causing scientists to lose time

Scientists need a means of conducting these tests without having to monitor the process for broken Durham tubes.

### G. BRIEF SUMMARY OF THE INVENTION

The invention is a fixed Durham tube assembled so it remains fixed in place inside a test tube, either as a single assembly with the containing test tube, as part of a stopper for the tube, or held in place via an expandable clip.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations pointed out in the appended claims.

### H. BRIEF DESCRIPTION OF THE SEVERAL VIEWS OF THE DRAWING

The attached drawings are provided as non-limiting examples of the invention:

FIG. 1—Section view of a Durham tube as part of a test tube stopper

FIG. 2—Section view of a Durham tube attached component to a test tube.

FIG. 3—Section view of a Durham tube constructed as a part of a test tube.

FIG. 4—Plan view of a Durham tube expandable clip.

### I. DETAILED DESCRIPTION OF THE INVENTION

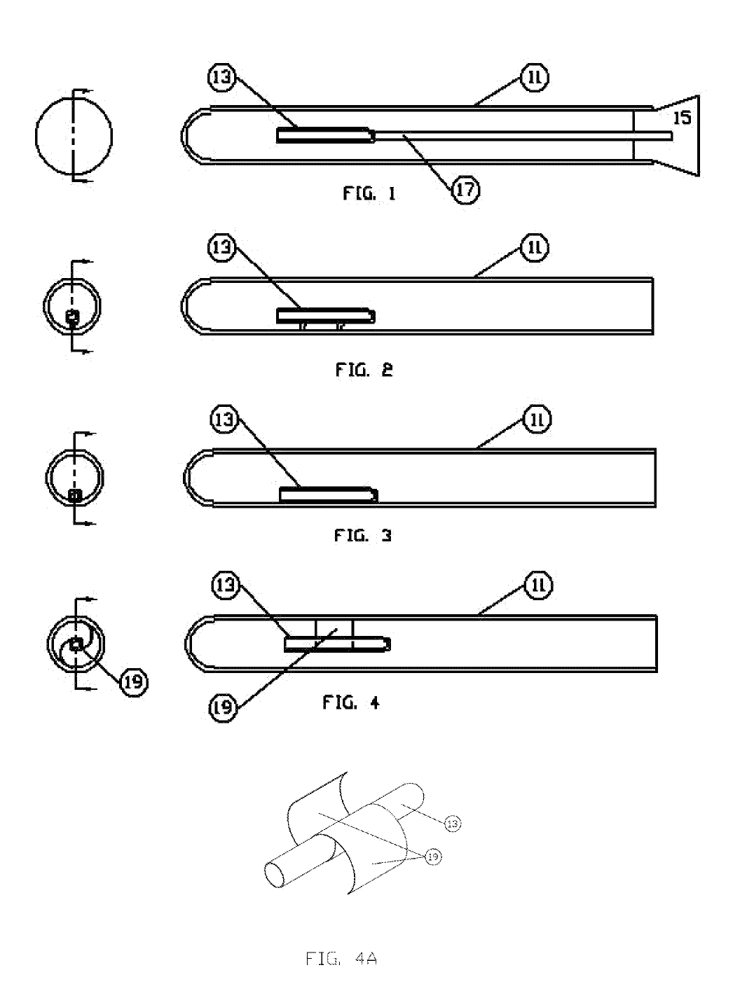

According to the present invention, the foregoing and other objects and advantages are attained by a Durham tube assembly as in FIGS. 1 and 2, comprising a test tube 11 and a Durham tube 13 rigidly held in place, inverted inside the test tube 11.

The Durham tube 13 can be held in place in one of several different ways. In FIG. 1, the tube 13 is an integral part of the stopper 15 to the test tube. FIG. 1 shows a conventional cork stopper 15, said stopper 15 with a hole in its bottom that allows an extension 17 to be inserted. The Durham tube 13 is at the bottom part of the extension 17. The tube 13 and extension 17 could be all one glass piece, with a hollowed out bottom portion serving as the Durham tube. Alternatively, a Durham tube could be welded to an extension 17, in either case, the typical configuration would be that the Durham tube 13, extension 17, and stopper 15 are all assembled into one working piece.

Another mode is shown in FIG. 2, in which the tube 13 is welded into place on standoffs, and becomes part of the test tube 11 as one assembly. The tube 13 could be welded so close to the interior of the tube 11 that it might appear to be created as one piece.

A third configuration is shown in FIG. 3, in which the tube 13 is welded directly to the interior wall of the test tube 11. This figure also represents what the end result would appear like if the Durham and test tube were created as one piece.

A fourth approach, shown in FIG. 4, would be to use an expanding clip 19 that is attached to the Durham tube 13 and then slid into the test tube 11 by compressing the clip 19 so it fits inside the test tube 11 and the clip expands to hold the Durham tube 13 in place.

The clip 19 could be made of many configurations, so long as it holds the Durham tube 13 in place. The clip 19 could have multiple elastic arms that center the Durham tube in the middle of the test tube as in FIG. 4, or just one arm which presses the Durham tube 13 to one side by pushing against the far wall of the test tube. A clip 19 might fit into one or more notches created in the interior of the test tube 11, or just use friction and spring-action of the clip's arms, as typified in FIG. 4. Users of this clip would have to ensure that the material of the clip would have be unaffected by the chemicals being used.

All of these methods would produce a Durham and test tube assembly that would prevent the Durham tube from excessive movement and any breakage. The Durham tube 13 and test tubes 11 are typically glass, but can be made of other materials, so long as they do not impact the testing.

1) A Durham tube assembly, comprising a Durham tube and test tube, in which a means is employed to hold the Durham tube rigidly in place.

2) An apparatus as in Claim One, in which the means used to hold the Durham tube in place is to construct the Durham tube and test tube as one piece.

3) An apparatus as in Claim One, in which the Durham tube is held in place by affixing it to the test tube stopper.

4) An apparatus as in Claim One, in which the Durham tube is held in place by a removable clip.
